(19) United States
(12) Patent Application Publication
(10) Pub. No.: US 2015/0030763 A1
(43) Pub. Date: Jan. 29, 2015

(54) COLORED MASKING LIQUID COMPOSITION AND METHOD OF USING

(71) Applicant: 3M INNOVATIVE PROPERTIES COMPANY, St. Paul, MN (US)

(72) Inventors: Kin-Chau Chan, Tamworth (GB); Gary N. Brotherton, Warwickshire (GB); Colin D. Sinclair, Coventry (GB); Jeffrey J. Schwab, Inver Grove Heights, MN (US); Craig G. Appleby, West Yorkshire (GB); Anna B. Baker, Nottingham (GB)

(73) Assignee: 3M Innovative Properties Company, St. Paul, MN (US)

(21) Appl. No.: 14/384,745

(22) PCT Filed: Mar. 14, 2013
(86) PCT No.: PCT/US2013/031255

§ 371 Date: Sep. 12, 2014

Related U.S. Application Data
(60) Provisional application No. 61/611,843, filed on Mar. 16, 2012.

(51) Int. Cl. C09D 5/00; C09D 7/12; C08K 5/053; C08K 5/17; C08K 3/22; C08K 3/28; B05B 15/12; C08K 5/1535

(52) U.S. Cl. CPC C09D 5/00; B05B 15/1237; C09D 7/1233; C08K 5/1535; C08K 5/17; C08K 3/22; C08K 3/28; C08K 5/053
USPC 427/154; 524/111

(57) ABSTRACT

The present invention provides a colored masking liquid composition, and a method of masking a paint spray booth, wherein the composition comprises one or more polymers dispersed or dissolved in water, a base in a sufficient amount to provide a pH greater than 7, and a pH indicator that is colored at the pH of the masking liquid composition. Applying the colored masking liquid composition to the interior surface of a spray booth and allowing to dry results in a colorless mask.

The present invention relates to a colored masking liquid composition for the protection of interior surfaces such as wall, window, and adjacent floor surfaces in and around a paint spray booth. In particular, the present invention relates to a method of masking the interior surfaces of a spray booth.

The manufacture of many goods requires the application of a decorative finish, either for appearance or protection. The application of a decorative finish is usually performed inside an enclosed area or spray booth. Generally, a spray booth encompasses a sealed chamber with a clean air supply and removal system. The item to be painted is placed inside the booth, and application of the paint is accomplished via hand or automatic spray equipment. Due to paint transfer efficiencies of usually 60% at best, a good deal of the sprayed paint becomes entrained in the booth air flow and ultimately is deposited on the interior surfaces and equipment inside the spray booth. This uncured paint “overspray” fouls the walls and floor and is easily tracked outside the paint booth by workers' shoes and equipment. If allowed to accumulate, this overspray limits visibility through windows in the spray booth, reduces airflow in the booth by narrowing the gap in floor grates, and creates unsafe work conditions by making walking surfaces and equipment slippery. Most spray booths comprise white colored interior surfaces so as to enable easy color matching.

To protect the white colored walls of spray booth from paint overspray, an aqueous liquid is used to cover the interior surfaces of the spray booth. These coating liquids are generally called booth coatings or masking liquids and are translucent white or clear transparent so as to retain the whiteness of the interior walls of the booth so as to enable an easy process of color matching of the substrate to be painted. The masking liquid is typically sprayed onto the white walls and the coating is then allowed to dry. Once dried, the coating acts as a barrier against paint overspray. When sufficient paint overspray gets deposited onto the wall, the “contaminated” coating is removed by washing off using water or peeling the coating.

In general, the application of such a translucent white or clear transparent coating on a white wall is difficult because of a lack in contrast between the painted and unpainted surface. The practitioner is thus faced with the challenge of assuring that enough masking liquid has been applied and that the masking coating does not contain defects. This tends to lead to an excessive use and application of the masking liquid.

It would now be desirable to find an improved method for applying a booth coating or masking liquid. In particular, such method should be compatible with existing application methods and masking liquids used. It would further be desirable that the method is cost effective and/or does not substantially add to the cost of masking liquids, particularly as those are only applied temporarily and need to be replaced on a more or less frequent basis. It would in particular be desirable that the obtained masking coating has substantially the same performance and appearance as current masking coatings in use and in particular it would be desired that the color matching ability is not impaired.

It is generally understood to one of ordinary skill in the art of color science that a difference between two color coordinates (L*a*b*), defined as ΔE, of less than 1.0 is imperceptible under standard daylight illumination. Empirically, it is also understood to one of ordinary skill in the art of color science that the threshold for a “just noticeable difference” (JND) in color is a ΔE of 2.3 under standard daylight illumination. The term “colorless” is defined herein as a coating having a ΔE less than 1.0 relative to the underlying substrate, while a just noticeable color difference corresponds to a ΔE greater than 2.3 relative to the underlying substrate.

One embodiment of the present invention provides a colored masking liquid composition comprising:
one or more polymers dispersed or dissolved in water;
a base in a sufficient amount to provide a pH greater than 7;
a pH indicator that is colored at the pH of the masking liquid composition.

Another embodiment of the present invention provides a colored masking liquid composition comprising:
one or more polymers dispersed or dissolved in water;
a base in a sufficient amount to provide a pH greater than 7;
a pH indicator that is colored at the pH of the masking liquid composition; whereby
upon applying said composition to a substrate, ΔE increases by at least 2.3 and upon drying, ΔE is less than 2.3, relative to the substrate.

Another embodiment of the present invention provides a kit for making a colored masking liquid, the kit comprising:
separate first and second parts; wherein
said first part comprises a masking liquid comprising one or more polymers dispersed or dissolved in water;
said second part comprises a base; wherein
either or both of said first and second part comprise a pH indicator that is colored at a pH of more than 7; and
upon mixing said first and second part and applying to a substrate, ΔE increases by at least 2.3 and, upon drying ΔE is less than 2.3, relative to the substrate.

Another embodiment of the present invention provides a method of masking an interior surface of a spray booth, the method comprising:
providing a masking liquid comprising one or more polymers dispersed or dissolved in water, a base in an amount sufficient to provide a pH greater than 7, and a pH indicator that is colored at the pH of the masking liquid;
applying the colored masking liquid to at least part of an interior surface of the spray booth in a sufficient quantity to increase ΔE by at least 2.3 relative to the interior surface; and
allowing the applied colored masking liquid to dry, whereby upon drying the ΔE is less than 2.3 relative to the interior surface.

The ΔE of the color masking liquid and the dried mask, relative to the interior surface, will depend on a number of factors, including but not limited to, the type and amounts of pH indicator and base, hold time before application, and the amount of color masking liquid applied.

It has been found that the colored masking liquid composition of the present invention provides for easy application, for example spraying, and thus provides ample contrast to the typical white colored surface of the interior surfaces of the spray booth. Upon drying, it has been found that a pH shift towards a neutral or slight acidic pH occurs leading to the pH indicator in the masking liquid to change from its colored state to a colorless state and hence following drying, the appearance of the masking or booth coating is substantially the same as the underlying substrate. In co-pending U.S. application 2011/049481, a kit for making a colored masking liquid, and a method of applying said liquid, was described. The present invention provides a colored masking liquid composition and a method of applying said composition. In particular, the present invention provides a colored masking liquid having improved hue, chroma and solvent compatibility that is also more environmentally friendly.

Optionally, to avoid any substantial interference with other components of the masking liquid composition during storage, the base may be kept separate from the masking liquid and be mixed into the masking liquid shortly before the masking liquid will be applied. Thus, there is also provided a kit of parts for use with the method, the kit comprising separate first and second parts, the first part comprising a translucent white or clear transparent masking liquid comprising one or more polymers dispersed or dissolved in water and the second part comprising a base, and wherein either or both of said first and second part comprise a pH indicator that is colored at a pH of more than 7 and whereby upon mixing said first and second part, a pH of the masking liquid is obtained at which the pH indicator exhibits color thereby obtaining a colored masking liquid.

The one or more polymers dispersed or dissolved in water used in the present invention may be any known or commonly used masking liquid, including those described in for example U.S. Pat. No. 6,232,392 (Warren et al.), US 2007/0207269 (Woodhall et al.), US 2002/0172770 (Woodhall et al.), U.S. Pat. No. 4,548,962 (Lindmark) and EP 405341 (Wilk). The masking liquid comprises one or more polymers dissolved or dispersed in water. Typically, the polymers are film forming polymers and are water dispersible or soluble in water. Examples of polymers that may be used in the masking liquid include polyols such as polyvinylalcohols including polyvinylacetates of various degrees of hydrolization, polyvinylpyrrolidones (PVP), starches, celluloses including carboxymethyl cellulose, hydroxyethyl cellulose, hydroxypropyl cellulose, algins, dextrins, gum Arabic, alginic acid, a cellulose gum, acrylic polymers such as styrene/acrylic acid copolymers, alkali swellable copolymers of acrylic and polyester with fatty acid or alcohol moieties having from 14 to 30 carbon atoms like acrylate/steareth-itaconate copolymer and/or alkali swellable acrylate/Ceteth-itaconate copolymer and any combinations of any of the foregoing. Typically used are PVP polymers or polyvinyl alcohols. The polymers typically comprise from about 1% to about 50% (weight percent of the masking liquid), preferably from about 3% to about 25%, more preferably from about 5% to about 15% or 20%, and most probably from about 7% or 10% to about 12% or 15%.

Generally, the colored masking liquid composition will further comprise one or more surfactants. Suitable surfactants include siloxane-based surfactants including silicone polyoxyalkylene copolymers, organosilicone-polyether copolymer surfactants, and the like. In certain embodiments, preferred siloxane-based surfactants include surfactants available under the trade designation “BYK” from BYK Chemie GmbH, West Germany. In certain embodiments the siloxane based surfactants include, for example, one available under the trade designation “BYK 347”. Other silicon-based surfactants can be identified for example in Hill (1999) Silicon Surfactants, Marcel Decker, New York. Further surfactants include, but are not limited to anionic surfactants, for example, alkyl sulfates obtained under the trade designation “RHODAPON”, ether sulfates obtained under the trade designation “RHODAPEX”, sulfonates obtained under the trade designation “RHODACAL”, dodecylbenzene sulfonates, alpha-olefin sulfonates, diphenyl oxide disulfonates, phosphate esters obtained under the trade designation “RHODAFAC”, carboxylates obtained under the trade designation “MIRANATE”, etc., cationic surfactants, for example, imidazolines obtained under the trade designation “MIRAMINE”, ethoxylated amines obtained under the trade designation “RHODAMEEN”, non-ionic surfactants, for example, nonylphenol ethoxylates obtained under the trade designation “IGEPAL” co series, octylphenol ethoxylates for example “IGEPAL CA” series, nonionic esthers for example obtained under the trade designation “ALKAMUL1”, oleyl alcohol thoxylates for example, obtained under the trade designation “RHODASURF”, ethoxylated mercaptans for example, obtained under the trade designation “ALCODET”, capped ethoxylates for example, obtained under the trade designation “ANTAROX”, blocked polymers, etc., and amphoteric surfactants for example “imidazoline” obtained under the trade designation “MIRAN”, fatty amine derivatives, for example, obtained under the trade designation “MIRATAINE” etc. In certain embodiments, the masking composition includes nonionic alkyl aryl surfactants such as those obtained under the trade designations “TRITON CF-1O” and “TRITON CF-12” from Rohm & Haas, Philadelphia, Pa. Also suitable is “TRITON X-I 00” and surfactants having fluorinated alkyl chains such as “FLUORAD” products sold by 3M Company, St. Paul, Minn., and “ZONYL” products sold by DuPont Company, Wilmington, Del., are also suitable. In addition, many embodiments include polyethoxy adducts or modified (poly)ethoxylates such as “TRITON DF-12” and “TRITON DF-16” sold by Union Carbide Corporation, Danbury, Conn. Other surfactants include nonylphenoxypolyethanol, such as “IGEPAL CO-660” made by GAF, polyoxyalkylene glycol, such as “MACOL 18” and “MACOL 19” made by Mazer Chemicals, Charlotte, N.C., acetylenic diol-based surfactants, such as “SURFYNOL 104A” made by Air Products, Allentown, Pa., and the like. Surfactants are typically used in an amount of 0.05% by weight up to 5% by weight.

In certain embodiments, the colored masking liquid composition may further contain a plasticizer to provide toughness and flexibility and in particular to prevent cracking of the film during drying and subsequent handling. Suitable plasticizers include, but are not limited to, glycerine, sorbitol, sugars (e.g. glucose, sucrose, levulose, dextrose, etc.), urea, triethylene glycol, polyethylene glycol, and other water soluble plasticizers. These plasticizers may be used alone, or in combination with each other. One combination of plasticizers is urea in combination with glycerine or glycerine derivatives such as glycerine monostearate or glycerine monooleate. Another particular combination is glycerin in combination with sorbitol.

The pH indicator should be colored at a pH above 7, for example at a pH of at least 7.5, or at least 8 or at least 8.5 or at least 9. At a pH below the pH where the indicator is colored, the indicator should be colorless or substantially colorless. In a particular embodiment, the pH indicator will transition to colorless at a pH at or below 8.5, for example at or below 8 or at or below 7.5. In principle any pH indicator having a pH transition as above described may be used in this invention. Particularly suitable for use in connection with this invention are phthalein compounds or phthalein based indicators. Examples thereof include phenolphthalein, o-cresolphthalein, o-cresolphthalein complexone, thymophthalein, alpha-naptholphtalein, xylenolphthalein, tetrabromophenolphthalein, guaiacolphthalein, dixylenolphthalein and carvacrolphthalein. Further suitable phthalein based indicators can be found in WO 06105191. Further indicators that may be used include ethyl-bis(2,4-dinitrophenyl)-acetate, nitramine, p-nitrobenzhydrazide and pinachrome.

The pH indicator may not be readily soluble in water and will in such circumstances first be dissolved in a water miscible organic solvent. Suitable water-miscible organic solvents include in particular alcohols such as ethanol, isopropanol, n-propanol, n-butanol, methanol, glycols and glycerol and glycol ethers such as butyl diglycol and methoxy propanol, ketones such as acetone and acetylacetone, ethyl acetate and the like. Following dissolution of the indicator in a suitable organic solvent, water may be added thereto to obtain an aqueous solution of the indicator. The weight ratio of water-miscible organic solvent to water may vary widely and will depend on the particular indicator used. Generally the weight ratio of water-miscible organic solvent to water may be between 2:1 and 1:10. The amount of indicator in the indicator solution may vary widely and will depend on the desired amount in the final mixture following mixing of the first and second part. Generally, the desired amount when the two parts are mixed together is between 0.001% and 0.2% or between 0.01% and 0.1%.

Suitable bases that may be used for this purpose include organic as well as inorganic bases. Examples include alkali and alkali earth metal hydroxides such as lithium hydroxide, sodium hydroxide, potassium hydroxide, magnesium hydroxide, strontium hydroxide, ammonium hydroxides, amines such as primary, secondary and tertiary alkanol amines including diethanol amine and triethanol amine, cyclic amines such as for example morpholine, and carbonates and bicarbonates, for example, potassium carbonate or sodium bicarbonate. The amount of base used is such so as to obtain a desired pH. Typically, the pH of the resulting masking liquid will be at least 7.5, for example at least 8, or at least 8.5 or at least 9.

The invention is further illustrated with reference to the following examples without however the intention to limit the invention thereto. All parts and percentages are by weight unless otherwise indicated. Unless otherwise noted, all reagents were obtained or are available from, VWR International, LLC, Lutterworth, Leicestershire, U.K., or may be synthesized by known methods.

### Part A.

### Solution A-1.

A solution of 4% by weight o-cresolphthalein (OCP) was prepared by dissolving 6 grams OCP in 144 grams isopropyl alcohol (IPA) at 21° C. 7.58 grams of this solution was then mixed with an equal weight of deionized water, and the solution then dissolved in 1,500 grams of a paint booth coating solution, obtained under the trade designation “CAL-WEST BOOTH COATING IV”, from Cal-West Specialty Coatings, Inc., Sunnyvale, Calif. The resulting solution contained 0.02% by weight OCP.

### Solution A-2.

The process generally described in Solution A-1 was repeated, wherein the weight of 4% OCP in IPA, and the weight of deionized water, added to the 1,500 grams of “CAL-WEST BOOTH COATING IV” were both increased to 11.42 grams. The resulting solution contained 0.03% by weight OCP.

### Solution A-3.

The process generally described in Solution A-1 was repeated, wherein the weight of 4% OCP in IPA, and the weight of deionized water, added to the 1,500 grams of “CAL-WEST BOOTH COATING IV” were both increased to 15.31 grams. The resulting solution contained 0.04% by weight OCP.

### Solution A-4.

The process generally described in Solution A-1 was repeated, wherein the weight of 4% OCP in IPA, and the weight of deionized water, added to the 1,500 grams of “CAL-WEST BOOTH COATING IV” were both increased to 23.20 grams. The resulting solution contained 0.06% by weight OCP.

### Solution A-0.

For comparative purposes, “CAL-WEST BOOTH COATING IV” is referred to as Solution A-0.

### Part B.

### Solution B-1.

An 80% by weight aqueous solution of triethanolamine (Part B) was prepared by dissolving 80 grams triethanolamine (TEA), grade “TELA PURE”, obtained from Univar, Inc., Widnes, Cheshire, U.K., in 20 grams deionized water at 21° C.

### Solution B-2.

Solution B-2 corresponded to 100% TELA PURE.

### Solution B-3.

A 0.66% by weight aqueous solution of sodium hydroxide.

### Solution B-4.

A 0.96% by weight aqueous solution of sodium hydroxide.

### Solution B-5.

A 1.06% by weight aqueous solution of potassium hydroxide.

### Solution B-6.

A 2.54% by weight aqueous solution of sodium carbonate

### Solution B-7.

A 2.52% by weight aqueous solution of potassium carbonate.

### Solution B-8.

A 9.5% by weight aqueous solution of ammonia.

### Solution B-9.

An aqueous solution comprising 58% of B-4 and 42% by weight glycerine.

### Solution B-10.

An aqueous solution comprising 58% of B-8 and 42% by weight glycerine.

### COMPARATIVES A-H AND EXAMPLES 1-12

The average background color of a 10.5 by 15 cm white spray out card, type “30060” obtained from Power-Tec Ltd., Southam, Warwickshire, U.K., was determined by measuring the L*a*b* values in three locations (top right, center and bottom left) of ten cards, using a model “CR400” colorimeter obtained from Konica Minolta Holdings, Inc., Warrington, Cheshire, U.K. The average L*a*b* values across all ten spray out cards was determined to be 86.74, −1.41 and −2.86, respectively.

### EXAMPLE 1

Solution B was homogeneously mixed into Solution A-1 according to the weight ratio listed in Table 1. A nominal target weight of 1.8 to 2.0 grams of this mixture was evenly applied onto a pre-weighed white spray out card using a paint cup assembly, type “Mini PPS” obtained from 3M Company, St. Paul, U.S.A., attached to a paint gun, model “MC-B” obtained from SATA GmbH & Co. KG, Kornwestheim, Germany, operating at 296.5 kiloPascals (kPa) and 21° C. The card was reweighed and, after placing a 1 mm plastic washer over the colorimeter probe to prevent contamination, the color of the wet coating, expressed as L*a*b* values, was immediately measured at the top right, center and bottom left locations. The card was then subjected to five drying cycles, wherein each cycle comprised placing the card in an oven, ramping the oven temperature up to 70° C., holding for one hour, then allowing the oven to cool to 21° C. for approximately one hour. After the fifth drying cycle the L*a*b* values were measured in the same locations as before.

### EXAMPLES 2-12 AND COMPARATIVES A-H

The procedure generally described in Example 1 was repeated, wherein the various Part A solutions were combined with Part B-1 solution, according to the ratios listed in Table 1.

The wet coating weights, expressed in grams per square meter (gsm), and the color of the coated spray out cards, taken as an average of the L*a*b* values in the three locations before and after drying, are reported in Table 2. The corresponding differences in color relative to the uncoated spray out card, expressed as ΔE, are listed in Table 3.

### EXAMPLES 13-42

The procedure generally described in Example 1 was repeated, wherein 140.0 grams Part A-2 solution was combined with the various Part B solutions, according to the amounts listed in Table 4. For examples 13-32, the average L*a*b* values across twenty five virgin spray out cards was determined to be 86.67, −1.29 and −2.94, respectively. For examples 33-44, the average L*a*b* values across eight virgin spray out cards was determined to be 86.75, −1.44 and −2.92, respectively. The corresponding wet coating weights and the color of the coated spray out cards, taken as an average of the L*a*b* values in the three locations before and after drying, are also reported in Table 4. The corresponding differences in color relative to the uncoated spray out card, expressed as ΔE, are listed in Table 5.

### EXAMPLES 43-44

The procedure generally described in Example 38 was repeated, wherein the wet coated L*a*b* values were measured are regular intervals immediately after the color masking liquid was applied to the spray out card, but before the composition had dried. Results are listed in Table 6.

As demonstrated by Examples 43 and 44, ammonia provides for rapid decolorization of the liquid masking composition, which may be beneficial in some spray booth applications. Within the time constraints for taking colorimetry measurements, it also explains the lower than expected ΔE (wet) values of Examples 40 and 42.

TABLE 1

| | | Weight | Weight | % By | % By |
|---|---|---|---|---|---|
| | Part A | Part A | Part B | Weight | Weight |
| Sample | Solution | (grams) | (grams) | OCP | TEA |
| Comparative A | A-0 | 147.06 | 0 | 0 | 0 |
| Comparative B | A-0 | 139.17 | 5.26 | 0 | 2.9 |
| Comparative C | A-0 | 138.82 | 9.76 | 0 | 5.3 |
| Comparative D | A-0 | 135.57 | 13.78 | 0 | 7.4 |
| Comparative E | A-1 | 139.21 | 0 | 0.020 | 0 |
| Example 1 | A-1 | 138.90 | 5.29 | 0.019 | 2.9 |
| Example 2 | A-1 | 139.99 | 9.64 | 0.019 | 5.2 |
| Example 3 | A-1 | 138.90 | 13.99 | 0.018 | 7.3 |
| Comparative F | A-2 | 144.95 | 0 | 0.030 | 0 |
| Example 4 | A-2 | 139.97 | 5.26 | 0.029 | 2.9 |
| Example 5 | A-2 | 139.89 | 9.60 | 0.028 | 5.1 |
| Example 6 | A-2 | 141.14 | 14.43 | 0.027 | 7.4 |
| Comparative G | A-3 | 140.00 | 0 | 0.040 | 0 |
| Example 7 | A-3 | 140.23 | 5.26 | 0.039 | 2.9 |
| Example 8 | A-3 | 140.47 | 9.66 | 0.037 | 5.2 |
| Example 9 | A-3 | 138.66 | 13.96 | 0.036 | 7.3 |
| Comparative H | A-4 | 140.00 | 0 | 0.060 | 0 |
| Example 10 | A-4 | 139.04 | 5.21 | 0.058 | 2.9 |
| Example 11 | A-4 | 139.87 | 9.65 | 0.056 | 5.2 |
| Example 12 | A-4 | 138.02 | 13.80 | 0.055 | 7.3 |

TABLE 2

| | Wet | | | | | | |
|---|---|---|---|---|---|---|---|
| | Coating | | | | | | |
| | Weight | Wet Coating | | | Dried Coating | | |
| Sample | (gsm) | L* | a* | b* | L* | a* | b* |
| Comparative A | 104.0 | 86.82 | −1.42 | −2.80 | 87.14 | −1.46 | −2.54 |
| Comparative B | 110.4 | 86.63 | −1.33 | −2.89 | 87.09 | −1.41 | −2.38 |
| Comparative C | 130.8 | 86.54 | −1.13 | −3.02 | 86.98 | −1.43 | −2.34 |
| Comparative D | 128.2 | 86.59 | −1.28 | −2.89 | 86.99 | −1.47 | −2.29 |
| Comparative E | 118.0 | 86.70 | −1.34 | −2.82 | 87.25 | −1.41 | −2.48 |
| Example 1 | 114.8 | 85.79 | −0.09 | −4.05 | 87.10 | −1.48 | −2.35 |
| Example 2 | 122.5 | 83.68 | 2.48 | −6.79 | 86.78 | −1.49 | −2.35 |
| Example 3 | 116.7 | 81.96 | 5.05 | −9.23 | 86.94 | −1.50 | −2.35 |
| Comparative F | 111.0 | 86.74 | −1.32 | −2.82 | 87.18 | −1.43 | −2.42 |
| Example 4 | 120.6 | 84.96 | 0.78 | −4.90 | 86.96 | −1.48 | −2.27 |
| Example 5 | 116.1 | 82.66 | 3.99 | −8.08 | 86.91 | −1.48 | −2.28 |
| Example 6 | 118.7 | 80.38 | 7.40 | −11.33 | 86.95 | −1.47 | −2.26 |
| Comparative G | 142.3 | 86.56 | −1.34 | −2.85 | 87.16 | −1.45 | −2.37 |
| Example 7 | 126.3 | 85.13 | 0.85 | −4.87 | 87.13 | −1.45 | −2.19 |
| Example 8 | 112.3 | 82.71 | 5.50 | −9.37 | 86.98 | −1.47 | −2.23 |
| Example 9 | 123.8 | 79.18 | 8.94 | −12.48 | 87.25 | −1.48 | −2.15 |
| Comparative H | 124.4 | 86.78 | −1.33 | −2.79 | 87.26 | −1.44 | −2.31 |
| Example 10 | 116.1 | 84.03 | 2.20 | −6.08 | 87.10 | −1.47 | −2.13 |
| Example 11 | 116.1 | 80.30 | 7.34 | −10.99 | 87.04 | −1.48 | −2.16 |
| Example 12 | 111.6 | 77.89 | 10.80 | −14.13 | 86.99 | −1.43 | −2.15 |

TABLE 3

| Sample | Wet Coating ΔE | Dried Coating ΔE |
|---|---|---|
| Comparative A | 0.12 | 0.52 |
| Comparative B | 0.15 | 0.60 |
| Comparative C | 0.39 | 0.58 |
| Comparative D | 0.20 | 0.64 |
| Comparative E | 0.10 | 0.64 |
| Example 1 | 2.01 | 0.64 |
| Example 2 | 6.32 | 0.53 |
| Example 3 | 10.26 | 0.56 |
| Comparative F | 0.10 | 0.63 |
| Example 4 | 3.49 | 0.64 |
| Example 5 | 8.55 | 0.61 |
| Example 6 | 13.77 | 0.65 |
| Comparative G | 0.19 | 0.65 |
| Example 7 | 3.43 | 0.78 |
| Example 8 | 10.37 | 0.68 |
| Example 9 | 16.03 | 0.88 |
| Comparative H | 0.12 | 0.76 |
| Example 10 | 5.54 | 0.83 |
| Example 11 | 13.57 | 0.77 |
| Example 12 | 18.82 | 0.76 |

TABLE 4

| | | | Wet | | | | | | |
|---|---|---|---|---|---|---|---|---|---|
| | | Weight | Coating | | | | | | |
| | Part B | Part B | Weight | Wet Coating | | | Dried Coating | | |
| | Solution | (grams) | (gsm) | L* | a* | b* | L* | a* | b* |
| Example 13 | B-2 | 7.6 | 147.2 | 83.90 | 4.02 | −8.02 | 87.38 | −1.47 | −1.54 |
| Example 14 | B-2 | 7.6 | 92.7 | 84.36 | 1.84 | −5.98 | 87.43 | −1.43 | −1.97 |
| Example 15 | B-2 | 7.6 | 157.6 | 83.12 | 3.52 | −7.55 | 87.33 | −1.42 | −1.83 |
| Example 16 | B-3 | 9.6 | 112.3 | 84.92 | 0.98 | −5.10 | 87.07 | −1.45 | −1.81 |
| Example 17 | B-3 | 9.6 | 151.8 | 84.52 | 1.67 | −5.67 | 87.35 | −1.54 | −1.22 |
| Example 18 | B-4 | 9.7 | 117.4 | 69.25 | 26.61 | −25.07 | 86.98 | −1.34 | −1.60 |
| Example 19 | B-4 | 9.7 | 139.7 | 65.73 | 30.53 | −29.37 | 86.85 | −1.41 | −1.37 |
| Example 20 | B-4 | 9.7 | 132.1 | 68.00 | 27.02 | −26.68 | 87.13 | −1.36 | −1.53 |
| Example 21 | B-5 | 9.6 | 146.7 | 80.82 | 6.90 | −10.58 | 87.35 | −1.51 | −1.19 |
| Example 22 | B-5 | 9.6 | 165.9 | 81.57 | 6.01 | −9.75 | 87.27 | −1.59 | −1.07 |
| Example 23 | B-5 | 9.6 | 168.4 | 80.66 | 7.32 | −10.90 | 87.21 | −1.51 | −0.89 |
| Example 24 | B-6 | 9.6 | 149.9 | 72.89 | 19.12 | −20.85 | 86.56 | −0.73 | −0.55 |
| Example 25 | B-6 | 9.6 | 145.5 | 73.89 | 17.56 | −19.72 | 86.72 | −1.06 | −0.67 |
| Example 26 | B-6 | 9.6 | 174.2 | 71.81 | 20.87 | −22.19 | 86.72 | −0.84 | −0.75 |
| Example 27 | B-7 | 9.6 | 155.7 | 81.59 | 5.99 | −9.72 | 87.49 | −1.74 | 0.04 |
| Example 28 | B-7 | 9.6 | 128.9 | 83.17 | 3.69 | −7.65 | 87.24 | −1.39 | −0.56 |
| Example 29 | B-7 | 9.6 | 141.6 | 82.61 | 4.44 | −8.35 | 87.19 | −1.63 | −0.08 |
| Example 30 | B-8 | 9.7 | 121.2 | 81.75 | 5.97 | −9.72 | 87.46 | −1.38 | −2.38 |
| Example 31 | B-8 | 9.7 | 137.2 | 79.44 | 9.02 | −10.44 | 87.34 | −1.37 | −2.35 |
| Example 32 | B-8 | 9.7 | 128.9 | 81.27 | 6.28 | −10.05 | 87.24 | −1.37 | −2.38 |
| Example 33 | B-4 | 9.7 | 109.1 | 61.12 | 38.21 | −34.27 | 86.82 | −1.74 | −0.93 |
| Example 34 | B-4 | 9.7 | 94.4 | 68.84 | 25.50 | −25.90 | 86.79 | −1.73 | −0.94 |
| Example 35 | B-9 | 16.7 | 109.7 | 64.91 | 31.67 | −30.31 | 86.39 | −1.71 | −1.16 |
| Example 36 | B-9 | 16.7 | 141.0 | 63.21 | 34.68 | −32.11 | 86.46 | −1.72 | −1.15 |
| Example 37 | B-9 | 16.7 | 100.8 | 73.37 | 18.18 | −20.41 | 86.52 | −1.66 | −1.29 |
| Example 38 | B-8 | 9.7 | 146.7 | 80.52 | 7.31 | −10.96 | 87.12 | −1.45 | −2.36 |
| Example 39 | B-8 | 9.7 | 135.9 | 80.76 | 7.06 | −10.74 | 87.16 | −1.46 | −2.36 |
| Example 40 | B-8 | 9.7 | 111.0 | 85.32 | 0.25 | −4.44 | 87.10 | −1.43 | −2.49 |
| Example 41 | B-10 | 16.6 | 109.7 | 80.84 | 6.63 | −10.54 | 86.82 | −1.46 | −2.59 |
| Example 42 | B-10 | 16.6 | 134.6 | 83.51 | 2.81 | −6.89 | 86.82 | −1.47 | −2.51 |

TABLE 5

| | Wet Coating ΔE | Dried Coating ΔE |
|---|---|---|
| Example 13 | 8.04 | 1.59 |
| Example 14 | 4.93 | 1.24 |
| Example 15 | 7.55 | 1.30 |
| Example 16 | 3.60 | 1.23 |
| Example 17 | 4.57 | 1.87 |
| Example 18 | 39.70 | 1.35 |
| Example 19 | 46.36 | 1.63 |
| Example 20 | 41.40 | 1.45 |
| Example 21 | 12.64 | 1.95 |
| Example 22 | 11.22 | 1.99 |
| Example 23 | 13.18 | 2.14 |
| Example 24 | 30.45 | 2.47 |
| Example 25 | 28.29 | 2.35 |
| Example 26 | 32.90 | 2.27 |
| Example 27 | 11.17 | 3.14 |
| Example 28 | 7.70 | 2.44 |
| Example 29 | 8.86 | 2.96 |
| Example 30 | 11.09 | 0.92 |
| Example 31 | 14.80 | 0.92 |
| Example 32 | 11.70 | 0.99 |
| Example 33 | 56.68 | 2.02 |
| Example 34 | 39.68 | 2.00 |
| Example 35 | 48.20 | 1.82 |
| Example 36 | 52.07 | 1.82 |
| Example 37 | 29.49 | 1.67 |
| Example 38 | 13.41 | 0.68 |
| Example 39 | 13.01 | 0.70 |
| Example 40 | 2.69 | 0.56 |
| Example 41 | 12.57 | 0.34 |
| Example 42 | 6.66 | 0.43 |

TABLE 6

| | | | Wet | | | | | |
|---|---|---|---|---|---|---|---|---|
| | | Weight | Coating | Time After | | | | |
| | Part B | Part B | Weight | Application | Wet Coating | | | |
| | Solution | (grams) | (gsm) | (seconds) | L* | a* | b* | ΔE |
| Example | B-8 | 9.7 | 156.9 | 10 | 74.70 | 16.12 | −18.19 | 26.20 |
| 43 | | | | 62 | 82.17 | 4.57 | −8.42 | 9.34 |
| | | | | 130 | 84.77 | 0.90 | −4.96 | 3.68 |
| | | | | 308 | 85.83 | −0.50 | −3.56 | 1.47 |
| Example | B-8 | 9.7 | 146.1 | 10 | 78.47 | 10.72 | −13.80 | 18.30 |
| 44 | | | | 62 | 84.71 | 1.70 | −5.72 | 4/68 |
| | | | | 125 | 85.55 | 0.36 | −4.39 | 2.61 |
| | | | | 185 | 86.39 | −0.72 | −3.35 | 0.91 |
| | | | | 247 | 86.58 | −1.17 | −2.98 | 0.32 |
| | | | | 400 | 86.49 | −1.28 | −2.85 | 0.32 |

1. A colored masking liquid composition comprising:
one or more polymers dispersed or dissolved in water;
a base in a sufficient amount to provide a pH greater than 7;
a pH indicator that is colored at the pH of the masking liquid composition.

2. A colored masking liquid composition according to claim 1, wherein said composition is colorless when dried.

3. A colored masking liquid composition according to claim 2, wherein said pH indicator comprises a phthalein.

4. A colored masking liquid composition according to claim 3, wherein said phthalein comprises o-cresolphthalein.

5. A masking liquid composition according to claim 2, wherein said one or more polymers are selected from polyvinylalcohols, polyvinylpyrolidones, polyvinyl acetates, starches, celluloses, arabic gum, algins, dextrins and acrylic polymers.

6. A masking liquid composition according to claim 2, wherein said base comprises an organic base.

7. A masking liquid composition according to claim 2, wherein said base is triethanolamine.

8. A masking liquid composition according to claim 2, wherein said base comprises an inorganic base.

9. A masking liquid composition according to claim 8, wherein said inorganic base comprises a hydroxide of an alkali metal or alkali earth metal salt.

10. A masking liquid composition according to claim 9, wherein said hydroxide of an alkali metal or alkali earth metal salt comprises sodium hydroxide and, or, potassium hydroxide.

11. A masking liquid composition according to claim 8, wherein said inorganic base comprises a carbonate of an alkali metal salt.

12. A masking liquid composition according to claim 11, wherein said carbonate of an alkali metal salt comprises sodium carbonate and, or, potassium carbonate.

13. A masking liquid composition according to claim 8, wherein said inorganic base comprises ammonium hydroxide.

14. A masking liquid composition according to claim 2, further comprising a plasticizer.

15. A masking liquid composition according to claim 14, wherein said plasticizer comprises glycerine.

16. A method of masking the interior surface of a spray booth, the method comprising:
providing a colored masking liquid comprising:
one or more polymers dispersed or dissolved in water;
a base in amount sufficient to such that the pH of the masking liquid is greater than 7;
a pH indicator that is colored at the pH of the masking liquid;
applying the colored masking liquid to at least part of an interior surface of the spray booth;
allowing the colored masking liquid to dry and form a mask; and whereby
said mask is colorless.

17. A method of masking the interior of a spray booth according to claim 16, wherein the ΔE of the applied masking liquid composition, relative to the interior surface of the spray booth, is greater than 2.3.

18. A method of masking the interior of a spray booth according to claim 17, wherein the ΔE of the mask, relative to the interior surface of the spray booth, is less than 2.3.

19. A method of masking the interior of a spray booth according to claim 17, wherein the ΔE of the mask, relative to the interior surface of the spray booth, is less than 1.

20. A kit of parts for making a colored masking liquid, the kit comprising:
a separate first part comprising a masking liquid comprising one or more polymers dispersed or dissolved in water;
a separate second part comprising a base; wherein
either or both said separate first and second parts comprise a pH indicator, said pH indicator is colored at a pH greater than 7; whereby
upon mixing said separate first and second parts forms a colored masking liquid.

21. A kit of parts according to claim 20, wherein said colored masking liquid is colorless when dried.
